(19) United States
(12) Patent Application Publication
(10) Pub. No.: US 2025/0115254 A1
(43) Pub. Date: Apr. 10, 2025

(54) HYBRID MOTION PLANNER FOR AUTONOMOUS VEHICLES

(71) Applicant: NEC Laboratories America, Inc., Princeton, NJ (US)

(72) Inventors: Buyu Liu, Cupertino, CA (US); Francesco Pittaluga, Los Angeles, CA (US); Bingbing Zhuang, Santa Clara, CA (US); Manmohan Chandraker, Santa Clara, CA (US); Samuel Sohn, East Brunswick, NJ (US)

(21) Appl. No.: 18/905,738

(22) Filed: Oct. 3, 2024

Related U.S. Application Data
(60) Provisional application No. 63/542,547, filed on Oct. 5, 2023.

(51) Int. Cl. B60W 50/00; B60W 60/00; G05B 13/02

(52) U.S. Cl. CPC B60W 50/0097; B60W 60/001; G05B 13/027; B60W 2050/0008; B60W 2050/0012; B60W 2050/0028; B60W 2552/10

(57) ABSTRACT

Systems and methods for a hybrid motion planner for autonomous vehicles. A multi-lane intelligent driver model (MIDM) can predict trajectory predictions from collected data by considering adjacent lanes of an ego vehicle. A multi-lane hybrid planning driver model (MPDM) can be trained using open-loop ground truth data and close-loop simulations to obtain a trained MPDM. The trained MPDM can predict planned trajectories with collected data and the trajectory predictions to generate final trajectories for the autonomous vehicles. The final trajectories can be employed to control the autonomous vehicles.

### RELATED APPLICATION INFORMATION

This application claims priority to U.S. Provisional App. No. 63/542,547, filed on Oct. 5, 2023, incorporated herein by reference in its entirety.

### BACKGROUND

### Technical Field

The present invention relates to controlling autonomous vehicles and more particularly to a hybrid motion planner for autonomous vehicles.

### Description of the Related Art

Autonomous driving vehicles have significantly improved over the years in terms of driving capability, comfort, and safety. Despite these improvements however, autonomous driving is still not recommended as the driving capability of autonomous vehicles still lags behind human drivers in terms of comfort and safety.

### SUMMARY

According to an aspect of the present invention, a computer-implemented method is provided for a hybrid motion planner for autonomous vehicles, including predicting trajectory predictions from collected data by employing a multi-lane intelligent driver model (MIDM) by considering adjacent lanes of an ego vehicle, training a multi-lane hybrid planning driver model (MPDM) using open-loop ground truth data and close-loop simulations to obtain a trained MPDM, and generating final trajectories for the autonomous vehicles with collected data and the trajectory predictions using the trained MPDM.

According to another aspect of the present invention, a system is provided for a hybrid motion planner for autonomous vehicles, including, a memory device, one or more processor devices operatively coupled with the memory device to predict trajectory predictions from collected data by employing a multi-lane intelligent driver model (MIDM) by considering adjacent lanes of an ego vehicle, train a multi-lane hybrid planning driver model (MPDM) using open-loop ground truth data and close-loop simulations to obtain a trained MPDM, and generate final trajectories for the autonomous vehicles with collected data and the trajectory predictions using the trained MPDM.

According to yet another aspect of the present invention, a non-transitory computer program product is provided including a computer-readable storage medium including program code for a hybrid motion planner for autonomous vehicles, wherein the program code when executed on a computer causes the computer to predict trajectory predictions from collected data by employing a multi-lane intelligent driver model (MIDM) by considering adjacent lanes of an ego vehicle, train a multi-lane hybrid planning driver model (MPDM) using open-loop ground truth data and close-loop simulations to obtain a trained MPDM, and generate final trajectories for the autonomous vehicles with collected data and the trajectory predictions using the trained MPDM.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for a hybrid motion planner for autonomous vehicles, in accordance with an embodiment of the present invention;

FIG. 2 is a block diagram illustrating a method of predicting trajectory predictions from collected data by employing a multi-lane intelligent driver model (MIDM) by considering adjacent lanes of an ego vehicle, in accordance with an embodiment of the present invention;

FIG. 3 is a block diagram illustrating a method of training a multi-lane hybrid planning driver model (MPDM) using open-loop ground truth data and close-loop simulations to obtain a trained MPDM, in accordance with an embodiment of the present invention;

FIG. 4 is a block diagram illustrating a system for MPDM, in accordance with an embodiment of the present invention;

FIG. 5 is a block diagram illustrating a system for a hybrid motion planner for autonomous vehicles, in accordance with an embodiment of the present invention;

FIG. 6 is a block diagram illustrating a vehicle system implementing a hybrid motion planner for autonomous vehicles, in accordance with an embodiment of the present invention; and

FIG. 7 is a block diagram illustrating a deep neural network for a hybrid motion planner for autonomous vehicles, in accordance with an embodiment of the present invention.

### DETAILED DESCRIPTION OF PREFERRED EMBODIMENTS

In accordance with embodiments of the present invention, systems and methods are provided for a hybrid motion planner for autonomous vehicles.

In an embodiment, a multi-lane intelligent driver model (MIDM) can predict trajectory predictions from collected data by considering adjacent lanes of an ego vehicle. A multi-lane hybrid planning driver model (MPDM) can be trained using open-loop ground truth data and close-loop simulations to obtain a trained MPDM. The trained MPDM can predict planned trajectories with collected data and the trajectory predictions to generate final trajectories for the autonomous vehicles. The final trajectories can be employed to control the autonomous vehicles.

Planning trajectories is still an issue in autonomous driving vehicles. A good planning model should be accurate to mimic human driving behaviors. Additionally, it should also provide comfortable yet safe driving experience.

Various methods have been proposed to address this problem under different scenarios. For example, learning-based methods may give high accuracy in open-loop cases but fail to generalize to unseen or corner cases. Open-loop cases are driving scenarios where there is a lack of real-time feedback from the environment.

On the contrary, rule-based algorithms are stable under majority of driving scenarios, e.g., close-loop cases, but cannot reflect the human-like behavior as well as their learning-based counterpart. Close-loop cases are driving scenarios where there can be continuous monitoring of driving results and adjustment of driving actions based on feedback.

There are mainly two lines of research in motion planning. The conventional rule-based models such as the intelligent driver model (IDM) have been very successful in real-world close-loop planning but fail to mimic human behaviors. With learning-based methods prove to be effective when measuring the L2 distance between the predicted results and ground truth (GT), a.k.a. open-loop cases. However, these methods suffer a lot in terms of planning stability and reliability under close-loop cases. While there is a growing body of ML-based motion planners, the lack of established datasets and metrics has limited the progress in this area. Existing benchmarks for autonomous vehicle motion prediction have focused on short-term motion forecasting, rather than long-term planning.

Other methods are not generalizable nor applicable in real-world driving scenarios. Additionally, other methods cannot perform common driving maneuvers such as lane changing. Further, other methods can generate oscillations which are repeated undesired fluctuations in vehicle behaviors that cannot be penalized by evaluation metrics due to the ignorance of long-term comfort in its design.

Compared to other methods, the present embodiments can combine rule-based and learning-based methods in a more systematic yet effective way by introducing multi-lane planning with close-loop training techniques. The present embodiments can provide human-like accurate, comfortable, and safe trajectories for autonomous vehicles. By considering adjacent lanes of an ego vehicle, the present embodiments improve the intelligent driver model (IDM) model by 11% in closed loop settings.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

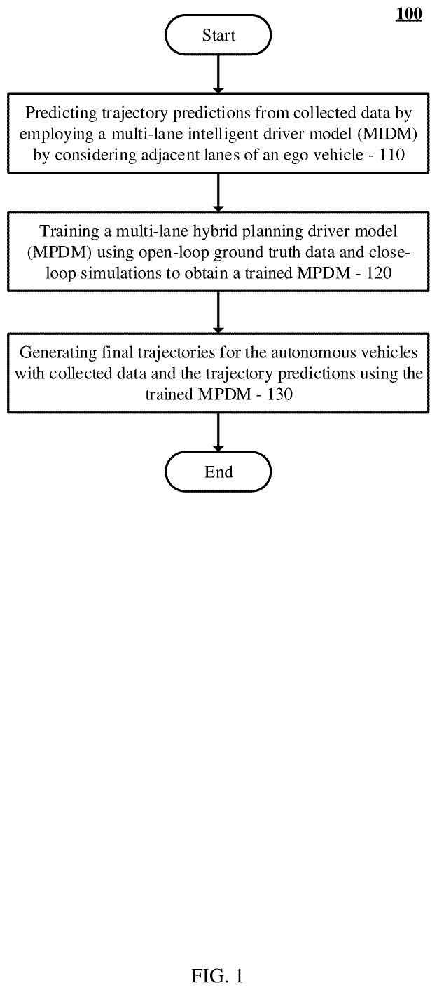

Referring now in detail to the figures in which like numerals represent the same or similar elements and initially to FIG. 1, a high-level overview of a method for a hybrid motion planner for autonomous vehicles is illustratively depicted in accordance with one embodiment of the present invention.

In an embodiment, a multi-lane intelligent driver model (MIDM) can predict trajectory predictions from collected data by considering adjacent lanes of an ego vehicle. A multi-lane hybrid planning driver model (MPDM) can be trained using open-loop ground truth data and close-loop simulations to obtain a trained MPDM. The trained MPDM can predict planned trajectories with collected data and the trajectory predictions to generate final trajectories for the autonomous vehicles. The final trajectories can be employed to control the autonomous vehicles.

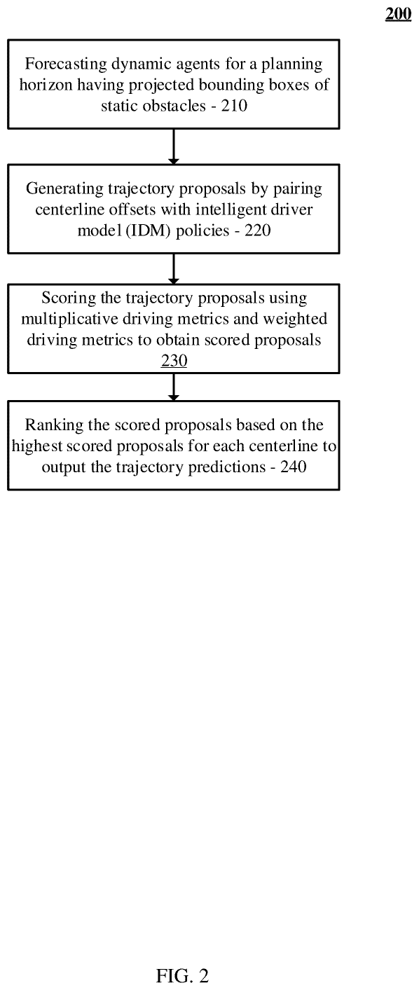

Referring now to block 110 of FIG. 1 that shows an embodiment of a method of predicting trajectory predictions from collected data by employing a multi-lane intelligent driver model (MIDM) by considering adjacent lanes of an ego vehicle. This method is described in more detail in FIG. 2.

Referring now to FIG. 2 showing an embodiment of a method of predicting trajectory predictions from collected data by employing a multi-lane intelligent driver model (MIDM) by considering adjacent lanes of an ego vehicle.

In contrast to the original IDM, MIDM module 200 utilizes Dijkstra, with the lane length as edge weights, to search for a sequence of lanes along the route and extract their centerline. Additionally, rather than considering only the lane the ego car is driving on, the present embodiments also take adjacent lanes into consideration.

Referring now to block 210 of FIG. 2 showing an embodiment of a method of forecasting dynamic agents and static obstacles for a planning horizon for a specific time. The present embodiments can forecast dynamic agents having projected bounding boxes for a planning horizon of a specific time (e.g., eight seconds) by assuming constant velocity and heading angle. The projected bounding boxes of the dynamic agents and static obstacles are stored in occupancy maps. Like IDM, the present embodiments add intersections on the route with a red traffic light as static obstacles.

Referring now to block 220 of FIG. 2 showing an embodiment of a method of generating trajectory proposals by pairing centerline offsets with intelligent driver model (IDM) policies.

The present embodiments can generate proposals by pairing centerline offsets (e.g., three offsets), and IDM policies (e.g., five policies) at varying target speeds, resulting in paired proposals (e.g., 15 pairs). Centerline offsets are deviations from a centerline. An IDM policy determines how a vehicle adjusts its longitudinal behavior (e.g., speed, acceleration, deceleration) based on objectives such as maintaining a desired speed, keeping a safe distance, and comfort. The present embodiments can use higher acceleration parameters than standard IDM to foster progress.

Referring now to block 230 of FIG. 2 showing an embodiment of a method of scoring the trajectory proposals using multiplicative driving metrics and weighted driving metrics to obtain scored proposals.

Multiplicative metrics can include at-fault collisions, drivable area infractions, and driving direction compliance. The weighted driving metrics can include progress, time-to-collision, and comfort which provides a weight (e.g., zero to one) for each metric. The present embodiments normalize the progress metric with the highest progress of a proposal which is free of multiplicative infractions. To score with the multiplicative metrics, a penalty (e.g., zero to one) is given for negative metrics (e.g., at-fault collisions and drivable area infractions) and a reward (e.g., zero to one) is given for positive metrics (e.g., driving direction compliance).

Referring now to block 240 of FIG. 2 showing an embodiment of a method of ranking the scored proposals based on the highest scored proposals for each centerline to output the trajectory predictions.

MIDM outputs the highest scored proposal for each centerline which is extended to the complete planning horizon of a specific time (e.g., eight seconds) with the corresponding IDM policy. The highest scored proposals that reaches a certain rank (e.g., up to the third ranked) can be the trajectory predictions.

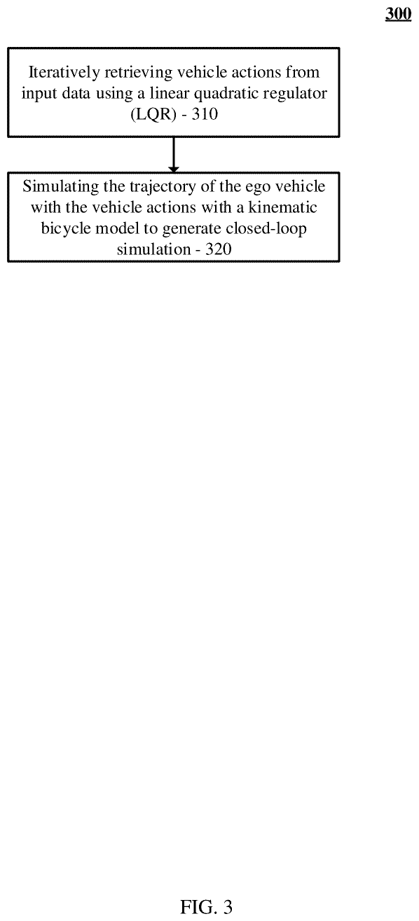

Referring back now to block 120 of FIG. 1 showing an embodiment of a method of training a multi-lane hybrid planning driver model (MPDM) using open-loop ground truth data and close-loop simulations to obtain a trained MPDM. This method is described in further detail in FIG. 3.

Open-loop ground truths (GT) as well as close-loop simulated results are obtained as the ground truth (GT) training data for MPDM. The open-loop GT can be provided by known dataset (e.g. nuPlan™). During training, the MPDM network can perform random sampling so that either open-loop GT or close-loop simulated GT would be selected and used for offset training.

Referring now to FIG. 3 which describes an embodiment of a method of generating close-loop simulations (300).

Referring now to block 310 showing an embodiment of a method of iteratively retrieving vehicle actions from input data using a linear quadratic regulator (LQR).

Trajectories from the known dataset are simulated by iteratively retrieving vehicle actions (e.g., changing direction, going straight, stopping, slowing down) from a linear quadratic regulator (LQR) controller. The iteration can run until a predefined threshold (e.g., natural number such as five, ten, etc.) has been met.

Referring now to block 320 showing an embodiment of a method of simulating the trajectory of the ego vehicle with the vehicle actions with a kinematic bicycle model to generate closed-loop simulations.

The trajectory of the ego vehicle can be simulated using the kinematic bicycle model using the input data of the ego vehicle that includes the position, heading angle, wheelbase and steering angle. In another embodiment, a different simulation model can be employed such as the dynamic bicycle model or pure pursuit model.

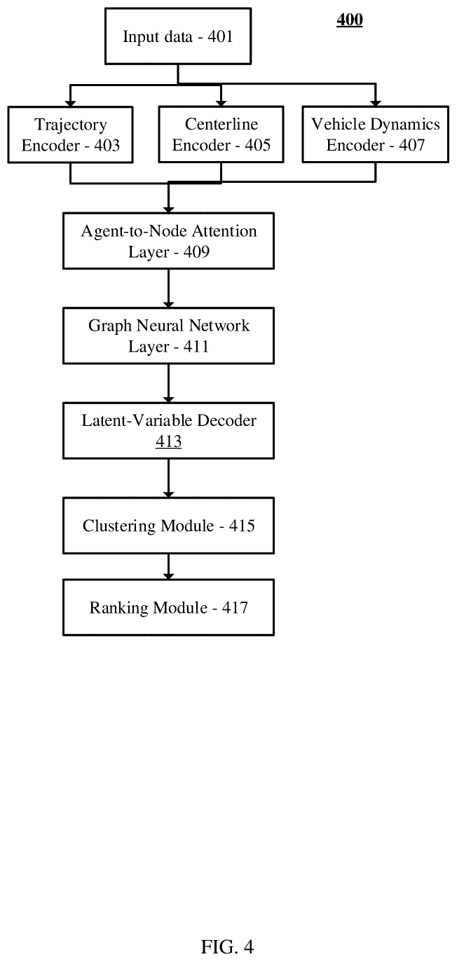

Referring back now to block 130 of FIG. 1 showing an embodiment of a method of generating final trajectories for the autonomous vehicles with collected data and the trajectory predictions using the trained MPDM. An embodiment of a system for the MPDM network is shown in FIG. 4.

Referring now to FIG. 4 that shows an embodiment of a system for the MPDM network.

The MPDM network 400 can receive input data 401 that includes an ego-centered lane graph representation, together with observed states of surrounding agents and the ego vehicle from the trajectory predictions obtained from MIDM. The nodes in the lane graph can include polylines of similar length, with directed edges for lanes in proximity or the direction of traffic flow.

The lane-nodes and dynamics of the surrounding agents and the ego vehicle are encoded with separate Gated Recurrent Units (GRUs) (e.g., trajectory encoder 403, centerline encoder 405 and vehicle dynamics encoder 407). The GRUs can obtain ego-motion encoding which is the output of the GRUs for the lane-nodes and dynamics of both surrounding agents and the ego vehicle.

The MPDM network 400 can aggregate the information by applying Agent-to-Node Attention Layer 409 and Graph Neural Network (GNN) layer 411, to yield a per-node feature representation. The node-feature are used to estimate transition probabilities for outgoing edges. Subsequently, traversals across the lane graph are sampled.

During inference, MPDM network 400 can mask out off-route edges to ensure goal-compliant traversals. Then, a latent-variable model decoder 413 can decode trajectories based on the traversals and the ego-motion encoding. The output trajectories are obtained after a k-means clustering with the clustering module 415 to obtain clustered trajectories. The MPDM network 400 can rank the clustered trajectories based on their posterior probabilities of how close the clustered trajectories adhere to generalized conditional gradient policy. The MPDM network 400 can select the cluster centers with the highest rank as the final trajectories. Other clustering algorithms can be used.

The present embodiments can optimize the trained MPDM by minimizing the Neighboring Agent Reactive L2 Error which computes how much the ego vehicle causes neighboring agents to deviate from their ground truth paths.

In an embodiment, a rule-first implementation can be employed by determining a rule-based plan first which is modified with learned corrections by the trained MPDM. In another embodiment, a learn-first implementation can be employed by determining a learned plan which is modified with rules to modify the acceleration of the vehicle based on a scenario's changing demands (e.g., the ego vehicle is going to hit a car or is moving too slowly, etc.). In another embodiment, the rule-first and learn-first implementations can be performed interchangeably depending on the optimal driving scenario for each implementation learned by the system. The optimal driving scenario for both rule-first implementation and the learn-first implementation can be learned by a neural network.

The present embodiments can combine rule-based and learning-based methods in a more systematic yet effective way by introducing multi-lane planning with close-loop training techniques. The present embodiments provides human-like accurate, comfortable, and safe trajectories for autonomous vehicles.

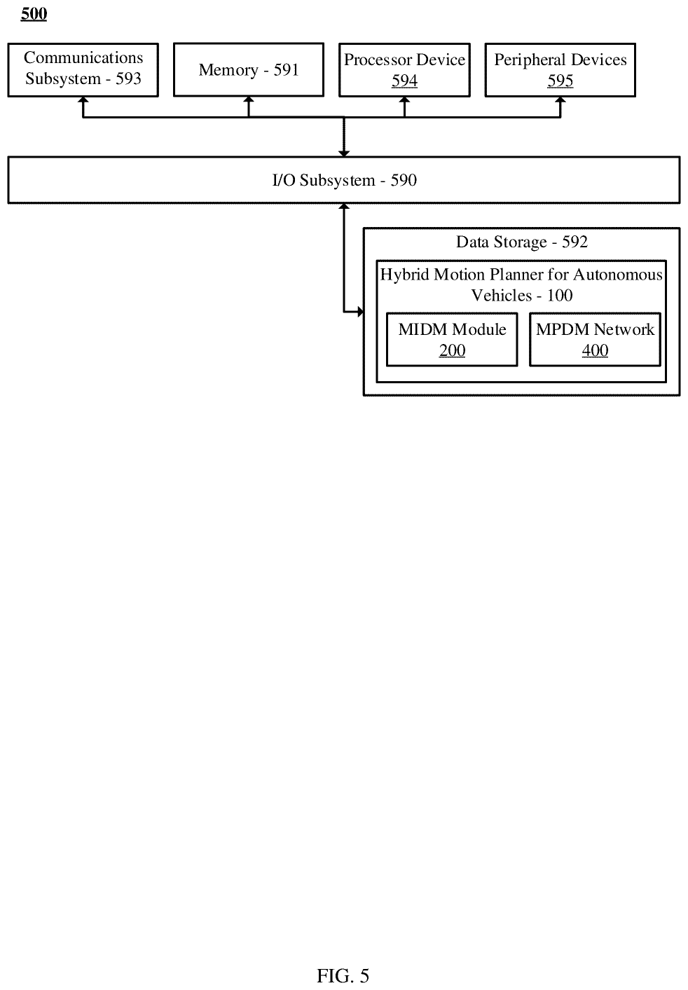

Referring now to FIG. 5, a system for a hybrid motion planner for autonomous vehicles is illustratively depicted in accordance with an embodiment of the present invention.

The computing device 500 illustratively includes the processor device 594, an input/output (I/O) subsystem 590, a memory 591, a data storage device 592, and a communication subsystem 593, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 591, or portions thereof, may be incorporated in the processor device 594 in some embodiments.

The processor device 594 may be embodied as any type of processor capable of performing the functions described herein. The processor device 594 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 591 may be embodied as any type of volatile or non-volatile memory or data storage capable of performing the functions described herein. In operation, the memory 591 may store various data and software employed during operation of the computing device 500, such as operating systems, applications, programs, libraries, and drivers. The memory 591 is communicatively coupled to the processor device 594 via the I/O subsystem 590, which may be embodied as circuitry and/or components to facilitate input/output operations with the processor device 594, the memory 591, and other components of the computing device 500. For example, the I/O subsystem 590 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 590 may form a portion of a system-on-a-chip (SOC) and be incorporated, along with the processor device 594, the memory 591, and other components of the computing device 500, on a single integrated circuit chip.

The data storage device 592 may be embodied as any type of device or devices configured for short-term or long-term storage of data such as, for example, memory devices and circuits, memory cards, hard disk drives, solid state drives, or other data storage devices. The data storage device 592 can store program code for a hybrid motion planner for autonomous vehicles 100 which can include the MIDM module 200 and the MPDM network 400. Any or all of these program code blocks may be included in a given computing system.

The communication subsystem 593 of the computing device 500 may be embodied as any network interface controller or other communication circuit, device, or collection thereof, capable of enabling communications between the computing device 500 and other remote devices over a network. The communication subsystem 593 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 500 may also include one or more peripheral devices 595. The peripheral devices 595 may include any number of additional input/output devices, interface devices, and/or other peripheral devices. For example, in some embodiments, the peripheral devices 595 may include a display, touch screen, graphics circuitry, keyboard, mouse, speaker system, microphone, network interface, and/or other input/output devices, interface devices, GPS, camera, and/or other peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 500 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

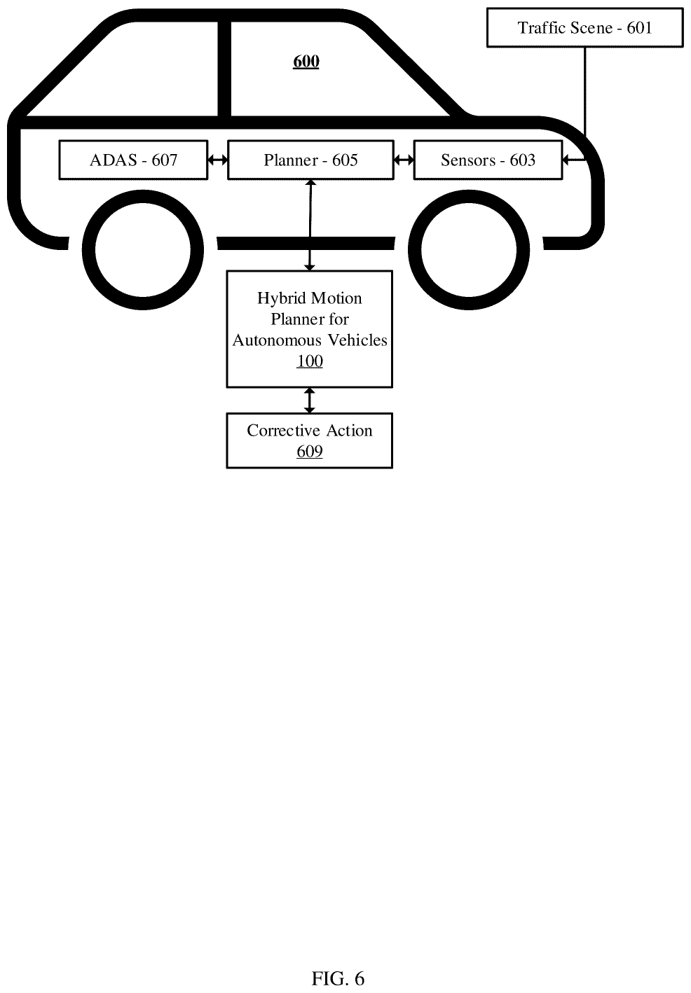

Referring now to FIG. 6, a block diagram of a system showing a practical application of a hybrid motion planner for autonomous vehicles, in accordance with an embodiment of the present invention.

An autonomous vehicle (AV) 600 can include sensors 603, planner 605, and advanced driver assistance system (ADAS) 607. The sensors 603 can include light detection and ranging (LiDAR) sensors, camera sensors, sound sensors, GPS sensors, yaw rate sensors, climate sensors, etc. The sensors 603 can collect the traffic scene 501. The traffic scene 601 can include the neighboring vehicles, the traffic road, the traffic conditions (e.g., weather, severity of traffic, temperature, etc.).

The planner 605 can implement the method of a hybrid motion planner for autonomous vehicles 100 which can generate final trajectories which can be employed to generate a corrective action 509. The corrective action 609 can include slowing the vehicle, changing lanes slowly or quickly, accelerating the vehicle, turning the vehicle slowly or quickly, braking, etc. The corrective action 609 can be performed by the ADAS 607 to actually control the vehicle 600.

In another embodiment, the planner 605 can be located in a remote server and can be connected to the autonomous vehicle 600 through a network.

The autonomous vehicle 600 can include motor vehicles such as cars, trucks, motorcycles, drones, or any machinery that can move.

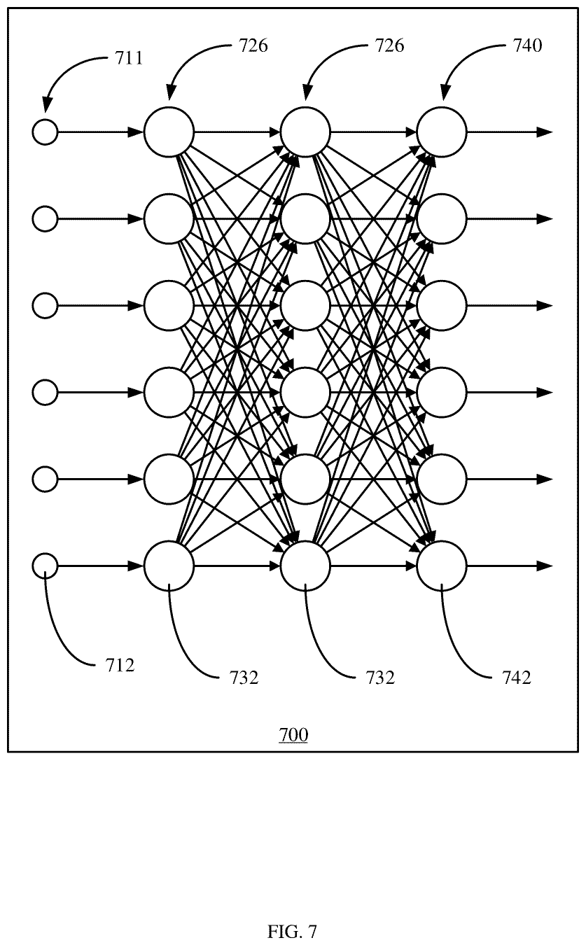

Referring now to FIG. 7, a block diagram illustrating deep learning neural networks for a hybrid motion planner for autonomous vehicles, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 700, such as a multilayer perceptron, can have an input layer 711 of source nodes 712, one or more computation layer(s) 726 having one or more computation nodes 732, and an output layer 740, where there is a single output node 742 for each possible category into which the input example can be classified. An input layer 711 can have a number of source nodes 712 equal to the number of data values 712 in the input data 711. The computation nodes 732 in the computation layer(s) 726 can also be referred to as hidden layers, because they are between the source nodes 712 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w1, w2, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

In an embodiment, the computation layers 726 of the MPDM can learn the planned trajectories of the ego vehicle for each lane in a traffic scene. The output layer 740 of the MPRDM can then provide the overall response of the network as a likelihood score of the planned trajectories of the ego vehicle for each lane in a traffic scene. In another embodiment, optimal driving scenarios to interchangeably select a rule-first implementation and a learn-first implementation can be learned by the present embodiments using a deep learning-based neural network.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 726 perform a nonlinear transformation on the input data 712 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for planning vehicle trajectories with a hybrid motion planner for autonomous vehicles, comprising:
predicting trajectory predictions from collected data by employing a multi-lane intelligent driver model (MIDM) by considering adjacent lanes of an ego vehicle;
training a multi-lane hybrid planning driver model (MPDM) using open-loop ground truth data and close-loop simulations to obtain a trained MPDM; and
generating final trajectories for the autonomous vehicles with collected data and the trajectory predictions using the trained MPDM.

2. The computer-implemented method of claim 1, further comprising controlling autonomous vehicles based on the final trajectories.

3. The computer-implemented method of claim 1, wherein predicting the trajectory predictions further comprises:
forecasting dynamic agents and static obstacles for a planning horizon;
generating trajectory proposals by pairing centerline offsets with intelligent driver model (IDM) policies;
scoring the trajectory proposals using multiplicative driving metrics and weighted driving metrics to obtain scored proposals; and
ranking the scored proposals based on highest scored proposals for each centerline to output the trajectory predictions.

4. The computer-implemented method of claim 1, wherein training the MPDM further comprises:
iteratively retrieving vehicle actions from input data using a linear quadratic regulator (LQR); and
simulating the trajectory of the ego vehicle with the vehicle actions with a kinematic bicycle model to generate closed-loop simulation.

5. The computer-implemented method of claim 1, wherein generating planned trajectories further comprises:
encoding lane-nodes of an ego-centered lane graph and dynamics of surrounding agents and the ego vehicle with gated recurrent units (GRU) to obtain encoded information;
aggregating the encoded information by applying agent-to-node attention and graph neural network layers to yield per-node feature representations (PFR);
estimating transition probabilities for outgoing edges using the PFR; and
sampling traversals across the ego-centered lane graph to obtain ego-motion encodings.

6. The computer-implemented method of claim 5, wherein generating planned trajectories further comprises:
masking off-route edges from the ego-centered lane graph to obtain goal-compliant traversals;
decoding trajectories based on the goal-compliant traversals and the ego-motion encodings to obtain output trajectories;
clustering the output trajectories with k-means clustering to obtain clustered trajectories; and
ranking the clustered trajectories based on a policy to obtain the planned trajectories as highest-ranked clustered trajectories.

7. The computer-implemented method of claim 1, further comprises optimizing the trained MPDM by minimizing a neighboring agent reactive L2 error.

8. A system for a hybrid motion planner for autonomous vehicles, comprising:
a memory device;
one or more processor devices operatively coupled with the memory device to:
predict trajectory predictions from collected data by employing a multi-lane intelligent driver model (MIDM) by considering adjacent lanes of an ego vehicle;
train a multi-lane hybrid planning driver model (MPDM) using open-loop ground truth data and close-loop simulations to obtain a trained MPDM; and
generate final trajectories for the autonomous vehicles with collected data and the trajectory predictions using the trained MPDM.

9. The system of claim 8, further comprising to control autonomous vehicles based on the final trajectories.

10. The system of claim 8, wherein to predict the trajectory predictions further comprises:
forecasting dynamic agents and static obstacles for a planning horizon;
generating trajectory proposals by pairing centerline offsets with intelligent driver model (IDM) policies;
scoring the trajectory proposals using multiplicative driving metrics and weighted driving metrics to obtain scored proposals; and
ranking the scored proposals based on highest scored proposals for each centerline to output the trajectory predictions.

11. The system of claim 8, wherein to train the MPDM further comprises:
iteratively retrieving vehicle actions from input data using a linear quadratic regulator (LQR); and
simulating the trajectory of the ego vehicle with the vehicle actions with a kinematic bicycle model to generate closed-loop simulation.

12. The system of claim 8, wherein to generate planned trajectories further comprises:
encoding lane-nodes of an ego-centered lane graph and dynamics of surrounding agents and the ego vehicle with gated recurrent units (GRU) to obtain encoded information;
aggregating the encoded information by applying agent-to-node attention and graph neural network layers to yield per-node feature representations (PFR);
estimating transition probabilities for outgoing edges using the PFR; and
sampling traversals across the ego-centered lane graph to obtain ego-motion encodings.

13. The system of claim 12, wherein to generate planned trajectories further comprises:
masking off-route edges from the ego-centered lane graph to obtain goal-compliant traversals;
decoding trajectories based on the goal-compliant traversals and ego-motion encodings to obtain output trajectories;
clustering the output trajectories with k-means clustering to obtain clustered trajectories; and
ranking the clustered trajectories based on a policy to obtain the planned trajectories as highest-ranked clustered trajectories.

14. The system of claim 8, further comprises to optimize the trained MPDM by minimizing a neighboring agent reactive L2 error.

15. A non-transitory computer program product comprising a computer-readable storage medium including program code for a hybrid motion planner for autonomous vehicles, wherein the program code when executed on a computer causes the computer to:
predict trajectory predictions from collected data by employing a multi-lane intelligent driver model (MIDM) by considering adjacent lanes of an ego vehicle;
train a multi-lane hybrid planning driver model (MPDM) using open-loop ground truth data and close-loop simulations to obtain a trained MPDM; and
generate final trajectories for the autonomous vehicles with collected data and the trajectory predictions using the trained MPDM.

16. The non-transitory computer program product of claim 15, further comprising to control autonomous vehicles based on the final trajectories.

17. The non-transitory computer program product of claim 15, wherein to predict the trajectory predictions further comprises:
forecasting dynamic agents and static obstacles for a planning horizon;
generating trajectory proposals by pairing centerline offsets with intelligent driver model (IDM) policies;
scoring the trajectory proposals using multiplicative driving metrics and weighted driving metrics to obtain scored proposals; and
ranking the scored proposals based on highest scored proposals for each centerline to output the trajectory predictions.

18. The non-transitory computer program product of claim 15, wherein to train the MPDM further comprises:
iteratively retrieving vehicle actions from input data using a linear quadratic regulator (LQR); and
simulating the trajectory of the ego vehicle with the vehicle actions with a kinematic bicycle model to generate closed-loop simulation.

19. The non-transitory computer program product of claim 15, wherein to generate planned trajectories further comprises:
encoding lane-nodes of an ego-centered lane graph and dynamics of surrounding agents and the ego vehicle with gated recurrent units (GRU) to obtain encoded information;
aggregating the encoded information by applying agent-to-node attention and graph neural network layers to yield per-node feature representations (PFR);
estimating transition probabilities for outgoing edges using the PFR; and
sampling traversals across the ego-centered lane graph to obtain ego-motion encodings.

20. The non-transitory computer program product of claim 19, wherein to generate planned trajectories further comprises:
masking off-route edges from the ego-centered lane graph to obtain goal-compliant traversals;
decoding trajectories based on the goal-compliant traversals and the ego-motion encodings to obtain output trajectories;
clustering the output trajectories with k-means clustering to obtain clustered trajectories; and
ranking the clustered trajectories based on a policy to obtain the planned trajectories as highest-ranked clustered trajectories.
